(19) United States
(12) Patent Application Publication
(10) Pub. No.: US 2014/0187148 A1
(43) Pub. Date: Jul. 3, 2014

(54) NEAR FIELD COMMUNICATION METHOD AND APPARATUS USING SENSOR CONTEXT

(71) Applicants: Shahar Taite, Kfar Saba (IL); David Kaplan, Jerusalem (IL); Israel Robotnick, Kiryat Gat (IL); Nurit Rosenbaum, Kiryat Gat (IL)

(72) Inventors: Shahar Taite, Kfar Saba (IL); David Kaplan, Jerusalem (IL); Israel Robotnick, Kiryat Gat (IL); Nurit Rosenbaum, Kiryat Gat (IL)

(21) Appl. No.: 13/727,848

(22) Filed: Dec. 27, 2012

(51) Int. Cl. H04B 5/00

(52) U.S. Cl. CPC H04B 5/00
USPC 455/41.1

(57) ABSTRACT

A sensor input into a first near field communication (NFC) device, such as an accelerometer input resulting from a rapid motion of the first NFC device to the right, is associated with a function of a second NFC device, such as a zoom function. The first NFC device is brought into proximity to a second NFC device and an NFC operation is launched. If the sensor input into the first NFC device is detected during a time window including the NFC launch time, the first NFC device communicates instructions to the second NFC device to execute the function, and the function is executed by the second NFC device.

### BACKGROUND

1. Field of the Invention

This invention pertains to wireless communication and more particularly to near field communication (NFC) devices and methods.

2. Description of the Related Art

Operations of digital electronic devices, such as computers, mobile telephones, smart phones, and tablet computers, are conventionally controlled by a physical input from a mouse, a keyboard, a touch screen or a touch pad or a joystick device. These devices are becoming more difficult to use as digital electronic devices, particularly mobile devices, become smaller. They even become difficult to use in traditional computers when operations need to be performed frequently. For example, a lap top that is locked at work many times a day often causes annoyance to the user because the user has to re-access control devices. A cell phone with a small keyboard can be particularly frustrating. Usually the unlocking function for a cell phone requires that four different key be touched in rapid succession, something that many of us cannot do easily, for example when one has just missed a telephone call and wants to return the call promptly.

It would be highly useful to have better and more useable ways to control functions of digital devices, particularly mobile devices that did not require access to a mouse, keyboard or other conventional physical input devices.

### BRIEF DESCRIPTION OF THE DRAWINGS

The invention will become clearly understood from the following detailed description read together with the drawings in which:

FIG. 1 is a diagrammatic view illustrating one embodiment of a control operation according to the invention;

FIG. 2 is a diagrammatic view illustrating another embodiment of a control operation according to the invention;

FIG. 3 is a diagrammatic view illustrating a further embodiment of a control operation according to the invention;

FIG. 4 is a diagrammatic view illustrating yet another embodiment of a control operation according to the invention;

FIG. 5 illustrates an embodiment of a NFC device according to the invention;

FIG. 6 is a diagrammatic view of an embodiment of an NFC system according to the invention showing exemplary elements of the invention;

FIG. 7 is a diagrammatic view illustrating another embodiment of a control operation according to the invention;

FIG. 8 is a diagrammatic view illustrating a further embodiment of a control operation according to the invention;

FIG. 9 is a flow diagram illustrating an embodiment of an NFC method according to the invention;

FIG. 10 is a flow diagram illustrating one embodiment of the read sensors subroutine 344 of FIG. 9; and

FIG. 11 illustrates several embodiments of a method according to the invention as may be performed with the apparatus of FIG. 5.

### DETAILED DESCRIPTION OF EMBODIMENTS OF THE INVENTION

The invention embodiments disclosed herein relate to near field communications or NFC. NFC is a short-range, high frequency wireless communication technology that enables the exchange of data between devices over about a small (e.g. 20 centimeter or less) distance. A NFC-enabled device communicates with another NFC-enabled device via a radio frequency signal (RF), generating a magnetic field, and typically operates within the 125 kHz and/or the 13.56 MHz frequency band. A NFC-enabled device senses another NFC-enabled device when the two are located within a device's magnetic field.

NFC is governed by a set of standards for smartphones and similar devices such as PCs, tablets, printers, consumer electronics, and appliances to establish radio communication with each other by touching them together or bringing them into close proximity, usually no more than a few centimeters. NFC standards cover communications protocols and data exchange formats, and are based on existing radio-frequency identification (RFID) standards including ISO/IEC 14443 and FeliCa. The standards include ISO/IEC 18092 and those defined by the NFC Forum.

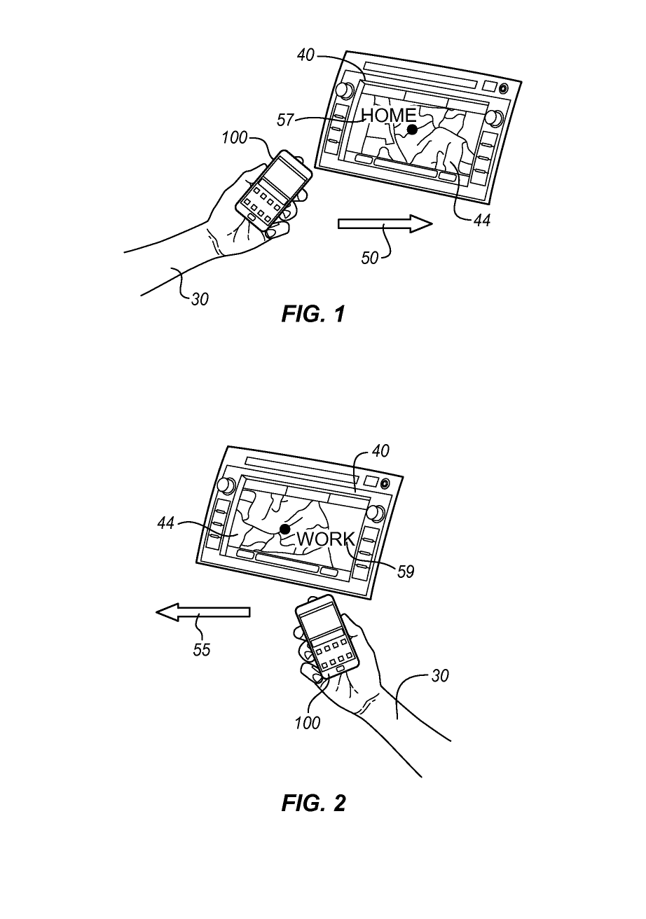

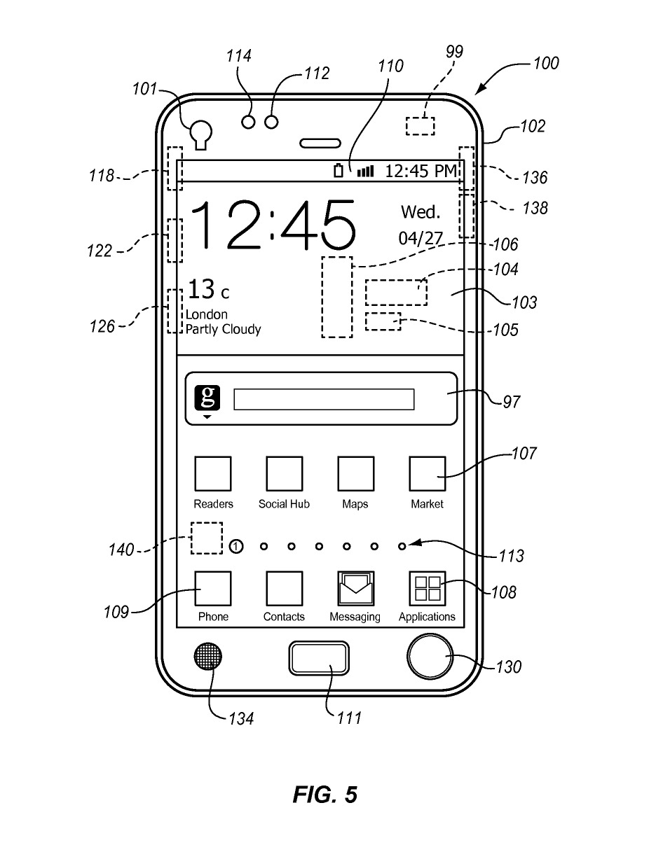

As mentioned above, in the prior art, control operations are typically performed using a mouse, keyboard or similar input device. In the embodiments disclosed herein, the method of the invention provides a more convenient and generally faster way to perform control operations. In an embodiment of the invention, pre- and post-near field communication tap information from one or more sensors provide additional context to the NFC tap to perform actions that are conventionally activated using a mouse, keyboard or other conventional input device. In this disclosure “tapping” refers to the action of the NFC devices coming into NFC proximity and the launch of an NFC operation. “Pre-tap” refers to an action that occurs before the NFC operation is launched. “Post-tap” refers to an action that occurs after an NFC operation is launched. One example is illustrated in FIG. 1, which shows a first NFC device 100 being used to control an operation of second NFC device 40. As will be explained in more detail below, the exemplary first NFC device is a smart phone 100 which contains an accelerometer 138 (FIG. 5). The exemplary second NFC device is an automobile navigation device 40, which includes a display 44. As illustrated in FIG. 1, first NFC device 100 is held in hand 30 which moves the device 100 rapidly to the right as shown by arrow 50. Device 100 records this movement, and if first NFC device 100 is brought into the proximity of second NFC device 40 and an NFC operation is launched between the devices within a first predetermined time before or a second predetermined time after the launch, first NFC device 100 instructs the second NFC device 40 to display directions 57 to take the automobile to the user's home. Turning now to FIG. 2, the same first NFC device 100 is moved by hand 30 rapidly in a direction to the left as shown by arrow 55. In this example, first NFC device 100 instructs second NFC device 40 to display directions 59 to take the automobile to the user's workplace. In the embodiments of FIGS. 1 and 2, a sensor, i.e., accelerometer 138 input, provides additional context to the NFC tap to control an operation that is conventionally controlled with a keyboard. When the user action required to perform the operation is compared to the user action to perform the same operation with a keyboard, it is evident that the invention provides a substantial improvement in usability of devices incorporating the invention.

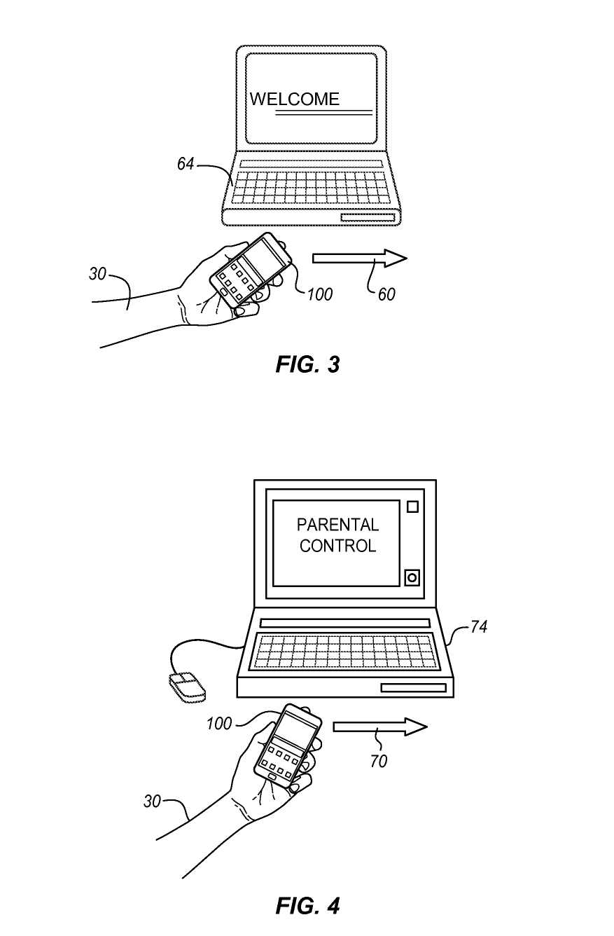

FIGS. 3 and 4 illustrate that the same movement of the first NFC device sensed at a different location adjacent a different second NFC device can result in different operations. In FIG. 3, hand 30 performs a rapid swipe to the right in front of a work computer 64 with an NFC function. In this example, performing the swipe in front of a work computer in a NFC tap window that also corresponds to a window about a meeting time on a calendar application in computer 64 causes the first NFC device 100 to instruct the second NFC device 64 to automatically transfer meeting presentation files to the first NFC device 100. In FIG. 4, the same operation performed at a home computer 74 causes the first NFC device 100 to instruct the second NFC device 74 to turn on the parental control on the second NFC device 74.

FIG. 5 illustrates an embodiment of a first near field communication (NFC) device 100 according to the invention. In this disclosure, first NFC device 100 will be described primarily in terms of a smart phone embodiment, such as a Galaxy™, iPhone™, Android™, Blackberry™, etc. However, it should be understood that this embodiment is only exemplary and provided to better explain the invention, and that device 100 could comprise any NFC device. NFC device 100 in one embodiment comprises a near field transceiver 101, case 102, a display 103, and internal electronics including a memory 104, a clock 105, and a microprocessor 106. Display 103 may comprise a touch screen having function specific areas, such as search area 105, touch screen buttons 107 which provides links to Internet sites, and touch screen buttons 108 that activate particular functions of the device 100, all of which buttons are identified by icons, such as phone icon 109. Display embodiment 103 also includes time and date area 110. Embodiment 100 also includes a hardware switch 111 that allows the user to toggle to the home screen or between different screens and a camera 112. Touch sensitive screen 103 may be sensitive to swipes across the screen which permits the user to access different screens, the screen being viewed being indicated by illuminated numbers in area 113. Device embodiment 100 also may include sensors that play an important role in the invention, which sensors include tilt sensor 99, light sensor 114, magnetometer 118, global positioning system (GPS) 122, proximity sensor 126, finger print sensor 130, microphone 134, gyro 136, accelerometer 138 and direction finder 140. Other sensors may also be included.

As known in the art, NFC transceiver 101 employs a one or more short-range wireless technologies, typically requiring a distance of 4 cm or less. NFC generally operates at 13.56 MHz on ISO/IEC 18000-3 air interface and at rates ranging from 106 kbit/s to 424 kbit/s. NFC generally involves an initiator and a target; the initiator may actively generate an RF field that can power a passive target. This enables NFC targets to take simple form factors such as tags, stickers, key fobs, or cards that do not require batteries. NFC peer-to-peer communication is possible, provided both devices are powered. NFC currently uses magnetic induction between two loop antennas located within each other's near field, effectively forming an air-core transformer. It may operate within the globally available and unlicensed radio frequency ISM band of 13.56 MHz. Most of the RF energy is typically concentrated in the allowed ±7 kHz bandwidth range, but the full spectral envelope may be as wide as 1.8 MHz when using Amplitude Shift Keying (ASK) modulation. Theoretical working distance with compact standard antennas may be up to 20 cm with a practical working distance of about 4 centimeters). Supported data rates may be 106, 212 or 424 kbit/s.

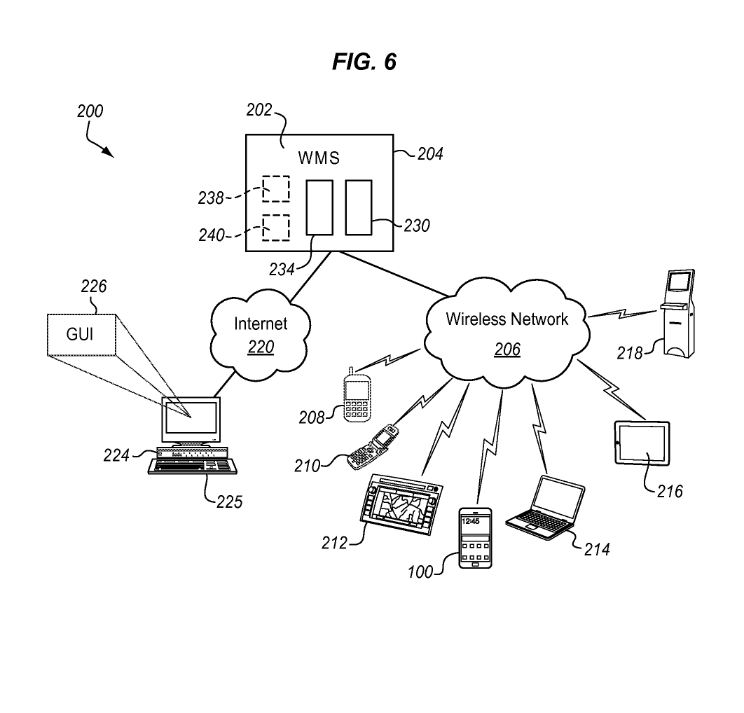

FIG. 6 is a diagrammatic view of one embodiment of an NFC system 200 according to the invention showing exemplary elements of the invention. The exemplary NFC system 200 includes a wireless management system (WMS) 292 that may reside on a server 204, a wireless network 206 various wireless devices such as smart phone 100, described above, and, in one exemplary embodiment, various other handhelds, such as GPS device 208, cell phone 210, automobile navigation unit 212, laptop computer 216, tablet computer 216, and kiosk 218. Many other wireless devices having an NFC transceiver also may be included. System 200 also may include Internet 220, controller computer 224 having an input device 225, such as a keyboard, and a graphical user interface 226. Computer 224 may communicate with wireless management system 204 via Internet 220. Server 204 may include memory 240 and processor 238. WMS 202 may include various databases, such as a contacts database 230 and a tap operations database 234. The databases, or a portion thereof, may also be incorporated into one or more of devices 224, 208, 210, 212, 100, 214, 216 and 218.

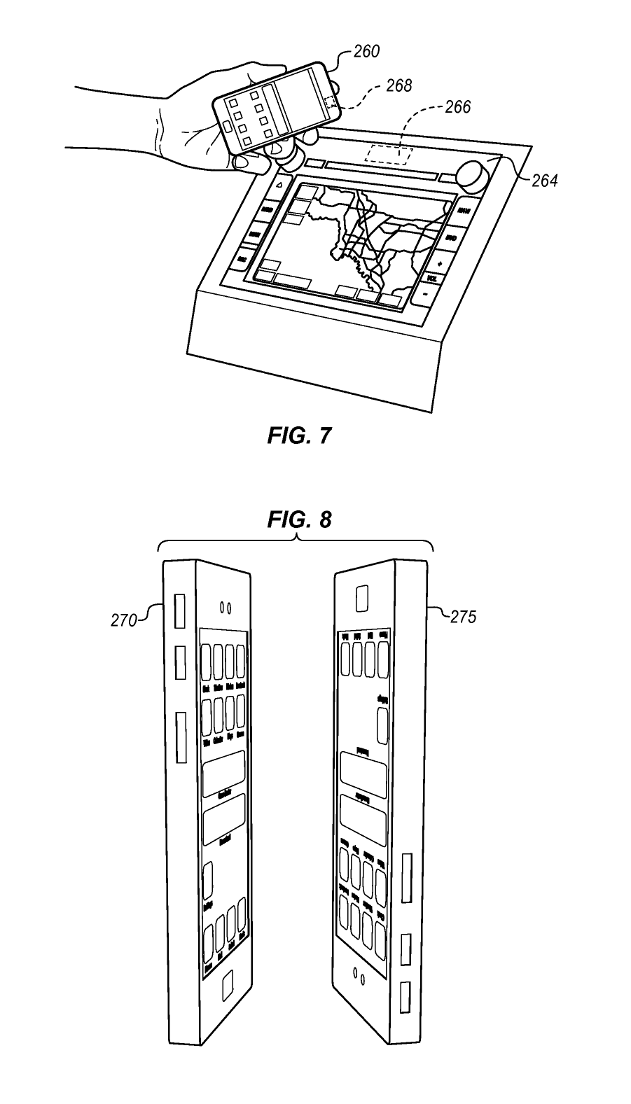

FIG. 7 is a diagrammatic view illustrating one embodiment of a control operation according to the invention. In this embodiment, a first NFC device 268, such as a smart phone with a direction finder 268, is held above a second NFC device, such as an automobile navigation unit 264 with a direction finder 266. The direction finders 268 and 266 sense the relative positions of the first NFC device 260 and the second NFC device 264 within a time window from a first time prior to the launch and a second time after the launch. If the devices determine that the first NFC device is above the second device within the time window, then the first device 260 communicates instructions to the second device 264 to perform an operation. As an example, the instructions may tell the navigation unit 264 to zoom in to show a close up picture of a map it is displaying. Holding the first device 260 below the device 264 and in close enough proximity to launch an NFC operation may cause instructions to be communicated from first device 260 to second device 264 to zoom out and provide a broader scope picture of a map it is displaying. Other instructions that may be communicated may be instructions to scroll the map. For example, holding the first device 260 to the left side of device 264 within the time window may cause first device 260 to communicate instructions to scroll the display to the left, while holding device 260 to the right within a time window about the time of launch may cause first device 260 to communicate instructions to scroll the display to the right. As a further example, holding the first device 260 above second device 260 as shown in FIG. 7 but rotating the device 260 180 degrees from the position shown in FIG. 7 within the time window, may cause instructions to be communicated from device 260 to device 264 to scroll the display upwards, while holding first device 260 below second device 264 within the time window but rotated 180 degrees may cause instructions to be communicated from device 260 to device 264 to scroll the display downward.

FIG. 8 is a diagrammatic view illustrating another embodiment of a control operation according to the invention. In the embodiment of FIG. 8, both the first exemplary NFC device 270 and the second exemplary NFC device are smart phones. First NFC device 270 is placed adjacent to second NFC device 275 but turned 180 degrees from the orientation of second device 275. As known in the art, both device 270 and device 275 know their individual orientation via sensing with accelerometers, such as 138 (FIG. 5), tilt sensors, such as 99, a combination of the two, or other sensing device(s). As examples of operations that may be controlled via relative orientation of the two NFC devices, a launch of an NFC operation in normal orientation combined with a fast movement horizontal movement as shown in FIG. 1 within the time window may increase the volume of the second NFC device 275 while the same fast movement within the time window followed by a reverse orientation may decrease the volume. As another example, a fast downward movement followed by a tap in normal relative orientation may increase the brightness of the display of the second NFC device 275, while the same fast downward movement within the time window followed by a tap in inverse relative orientation may decrease the brightness. One skilled in the art will see from the above that contrast of the display could also be controlled in a similar manner.

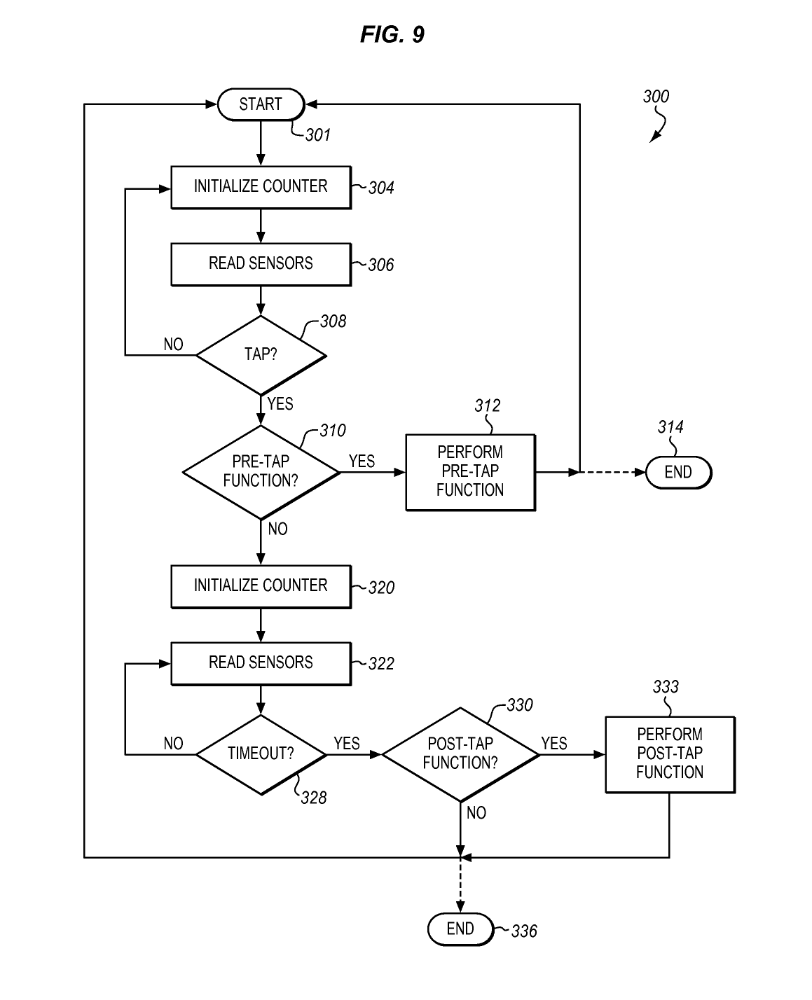

FIG. 9 is a flow diagram illustrating an exemplary embodiment of an NFC method 300 according to the invention. The method starts at 301. First a software clock or counter is initialized at 304. The sensors are read at 306. The sensors that are read can be all the sensors described above, a selection of the sensors, or other sensors. At 308, the system checks to see if a near field communication (NFC) has been launched, i.e., there has been a tap. If the NFC has not been launched, the system returns to 304 and reinitializes the counter. If there has been a tap, then the system goes to 310 where it determines if a pre-tap function is part of the programming. If a pre-tap function is indicated, the system goes to 312 and the first NFC device instructs the second NFC device to perform the function and the function is performed. The process then returns to start at 301. Alternatively, the process could end at 314 and subsequently restarted by a system interrupt.

If no pre-tap function is indicated at 310, then the counter is initialized at 320 then the sensors are read at 322. At 328, it is determined if the counter has timed out. If it has not timed out, the system returns to 322 and the sensors are read again. If the counter has timed out, the system checks at 330 to see if there is a post-tap function indicated. If there is, the system advances to 333, and the post-tap function is launched and executed. The system 300 then returns to START 301 or may go to end 336 and wait for a system interrupt to start the process 300. If no post-tap function is indicated at 330, the system returns to START 301, or, alternatively ends at 336 and is subsequently restarted by a system interrupt.

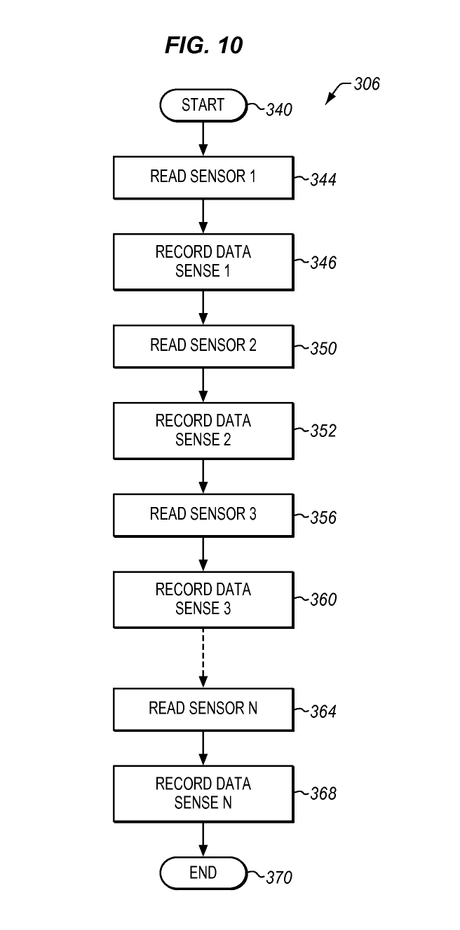

FIG. 10 is a flow diagram illustrating one embodiment of the read sensors subroutines 306, 322 of FIG. 9. At 340 the subroutine starts. At 344 the first sensor is read, and at 346 the first sensor data is recorded in memory 104. At 350, the second sensor is read, and at 352 the data from the second sensor is recorded in memory 104. The third sensor, if there is one, is read at 356 and the data from the third sensor is recorded in memory 104 at 360. The system then continues reading sensors and recording data until the last or nth sensor is read at 364 and then recorded at 368. The read routine ends at 370 and the system proceeds as described in connection with FIG. 9.

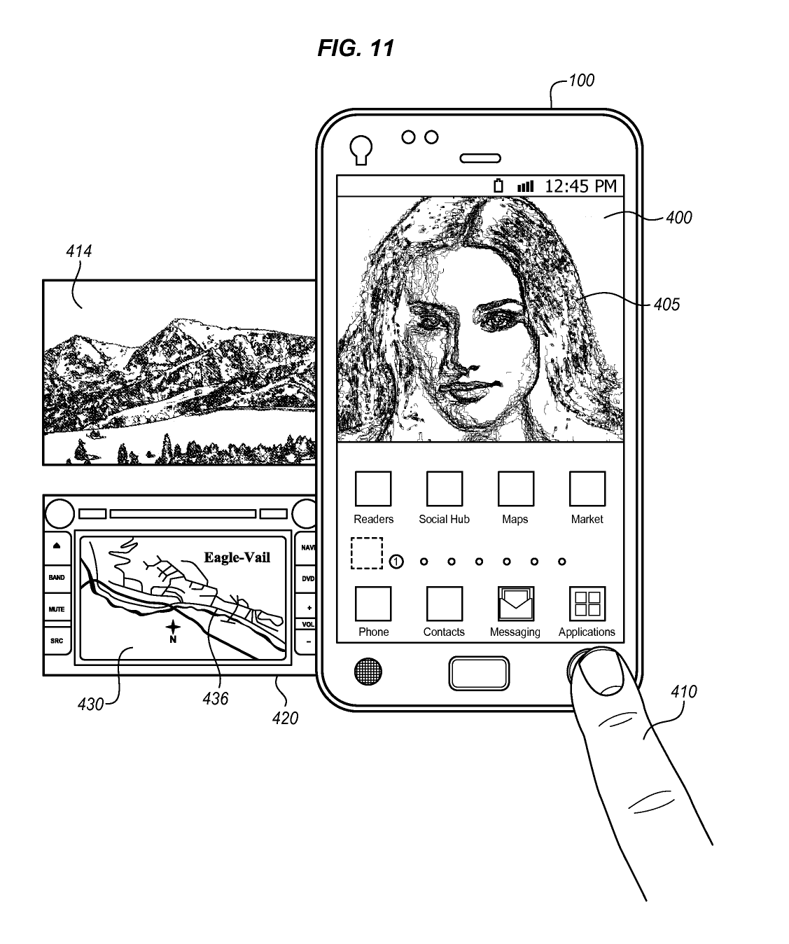

FIG. 11 illustrates several embodiments of a method according to the invention as may be performed with the apparatus 100 of FIG. 5. FIG. 11 includes an exemplary NFC device 100 as described in connection with FIG. 5, in which the screen 400 is exhibiting a picture 405 of a specific person. In one embodiment, if a fast horizontal movement as shown in FIG. 1 is performed in a time window including the tap event, the second NFC device 420 provides a display 430 showing directions to the specific person's address as recorded in contacts database 230. In addition, FIG. 11 also illustrates that a tap event may occur at a particular location, such as a location in the mountains 414, for example at the Vail Ski resort west of Denver, Colo. The location may be sensed by GPS 122 (FIG. 5), magnetometer 118, a combination of the two, or other sensor. If a fast horizontal movement as shown in FIG. 1 is performed in a time window including the tap event and the person's picture 405 or other information regarding the person is displayed on the first device 100 within the same time window, the second NFC device 420 may be instructed to provide a display 436 showing directions to the specific person's address in Vail as recorded in contacts database 230.

FIG. 11 also shows a finger 410 pressed against finger print sensor 130. As known in the art, the finger print sensor senses the finger print pressed against the finger print sensor and the system 200 identifies the person having the finger print. According to one embodiment of the invention, if a finger print is sensed within a predetermined time window including a tap event, first NFC device 100 communicates to a second NFC device, such as kiosk 218 (FIG. 6), that a specified person has been sensed and identified and provides instructions to verify an operation, such as a financial transaction that was launched by the tap event within the time window.

In an embodiment, the invention provides a method 300 for operating a near field communications (NFC) device 100, the method comprising: associating a first sensor input 306 into a first NFC device with a function of a second NFC device 40, the first sensor input being different than an input that launches an NFC operation; bringing the first NFC device 100 into proximity to the second NFC device 40, 64, 74, 420, detecting the proximity, and, at an NFC launch time, launching 308 an NFC operation between the first NFC device 100 and the second NFC device 40; sensing the first sensor input into the first NFC device during a time window including the NFC launch time; communicating instructions from the first NFC device to the second NFC device to execute the function; and executing 312, 330 the function in the second NFC device. In one embodiment, the sensing during a time window comprises sensing between a first time before the launching and a second time after the launching. In one embodiment, the sensing the first sensor input comprises sensing an input from a device selected from one or more of the following devices: a proximity sensor 126; an accelerometer 138; a gyroscope 136; a magnetometer 118; a light sensor 114; a GPS sensor 122; a clock 105; a finger print sensor 130; a microphone 134; and a direction finder 140. In another aspect, the sensing a first sensor input comprises sensing a parameter selected from the group consisting of: the direction or speed of movement of the first NFC device with respect to the second NFC device; the orientation of the first NFC device with respect to the second NFC device; the position of the first NFC device with respect to the second NFC device; the position of the first NFC device or the second NFC device with respect to an object that is not the first NFC device nor the second NFC device; the ambient light at the location of the first NFC device or the second NFC device; the strength or direction of the earth's magnetic field at the location of the first NFC device or the second NFC device; the distance between the first NFC device and the second NFC device; a fingerprint; and a sound. The function to be performed by the second NFC device may comprise a function selected from the group consisting of: zooming; scrolling; changing sound volume; displaying a selected display; transferring a file; and activating a control function. The time window may be five minutes or less, or alternatively it may be one minute or less, and in another embodiment, it may be thirty seconds or less.

In one embodiment, the associating may comprise associating the combination of the first sensor input into the NFC device and a second input into the NFC device with a function of the second NFC device. In this embodiment, if the first sensor input into the first NFC and the second input into the first NFC device are detected during the time window including the NFC launch time, then the first NFC device communicates to the second NFC device to perform a function associated with the combination of inputs. In one embodiment, the first NFC device comprises a display 103 and the second input into the first NFC device is selected from the group comprising: a GPS location 414; and a content 405 of the display. As an example, the content may comprise a picture 405 on the display.

In another embodiment, the invention provides a near field communication device (NFC) 100 comprising: (a) an NFC transceiver 101 for receiving and sending NFC signals, the NFC signals including an NFC launch signal; a memory 104; and a microprocessor 106; (b) a sensor for sensing a first physical parameter and for generating a first sensor signal characteristic of the first physical parameter; (c) a clock 105 for generating a time signal; and (d) an algorithm 300 stored in the memory, the algorithm: configured to correlate a first function to be performed by a separate NFC device with the first sensor signal; configured to launch an NFC operation upon the NFC receiver detecting an NFC launch signal; configured to, responsive to the time signal, determine a time window including the time of the launch of the NFC operation; and, configured to communicate instructions to execute the first function upon receiving the first sensor signal within the time window. In one embodiment, the sensor is selected from the group consisting of: a proximity sensor 126; an accelerometer 138; a gyroscope 136; a magnetometer 118; a light sensor 114; a GPS sensor 122; a clock 105; a finger print sensor 130; a microphone 134; and a direction finder 140.

In another embodiment, the invention provides a near field communication (NFC) system 200, comprising: a wireless management system 202 communicating with a wireless network 206, the wireless network including: a microprocessor 238; a clock 105 for producing a time signal; a first NFC device 100 having a first sensor for sensing a physical parameter and providing a first sense signal characteristic of the physical parameter; and the wireless management system further comprising a computer readable medium embodying instructions for directing the processing unit to: associate the first sense signal with a first function of a second NFC device; store instructions for an NFC operation; detect the proximity of the first NFC device to the second NFC device and launch the NFC operation in the second NFC device in response to the proximity detection; responsive to the time signal, generate a time window including the time of the launching of the NFC operation; receive the first sense signal; and in response to receiving the first sense signal within the time window, communicate instructions from the first NFC device to the second NFC device to execute the first function. The sensor may be selected from the group consisting of: a proximity sensor 126; an accelerometer 138; a gyroscope 136; a magnetometer 118; a light sensor 114; a GPS sensor 122; a clock 105; a finger print sensor 130; a microphone 134; and a direction finder 140. In one embodiment, the instructions to associate may comprise instructions to associate the combination of the first sense signal and a second input into the NFC device with a second function of the second NFC device; and the instructions to communicate instructions for the first NFC device to the second NFC device may comprise instructions to, in response to receiving the first sense signal and the second input during the time window including the NFC launch time, communicate instructions from the first NFC device to the second NFC device to execute the second function. In one embodiment, the first sensor signal is selected from a group of signals consisting of signals characteristic of: the direction or speed of movement of the NFC device with respect to the separate NFC device; the orientation of the NFC device with respect to the separate NFC device; the position of the NFC device with respect to the separate NFC device; the position of the NFC device or the separate NFC device with respect to an object that is not the NFC device nor the separate NFC device; the ambient light at the location of the NFC device or the separate NFC device; the strength or direction of the earth's magnetic field at the location of the NFC device or the separate NFC device; the distance between the NFC device and the separate NFC device; a fingerprint; and a sound; and the second input is selected from: a location determined from a global positioning system (GPS) 122; and the content 405 of a display.

The microprocessor which performs the algorithm or instructions, such as 238 or 106 may be in the wireless management system, the control device 224, or the NFC device such as 100. The second NFC device, such as 40, 275 may be a passive device or an active device.

While one embodiment of the invention has been described for the most part in terms of the sensing of a single sensor signal, it is contemplated that signals from multiple sensors may be required to activate the communication and performance of the function 312, 330 in the second NFC device. Another feature of one embodiment of the invention is that the combination of one sensed action of the first NFC device 100, such as the motion shown in FIG. 1, may result in one function, such as the display of the directions 57 to one's home, while the same sensed action, when accompanied by a second input, such as the picture 405 may result in a different or modified function, such as the display of directions to the home of the person whose picture is displayed. Further, the combination of the above two signals with yet a third signal, such as a GPS location 414, may result in a yet a different or differently modified function, such as the display of directions to the person's home near the GPS location.

A further feature of an embodiment of the invention is the invention is easier to use than conventional methods of controlling a second NFC device, such as 40, 64, 264 and 275, particularly when the user is occupied with other actions, such as driving a car. When driving a car, or on the telephone in an office, it takes time and a shift in concentration to use a conventional control device, while the invention requires much less shift in attention.

Another feature of an embodiment of the invention is that it offers the ability to control and perform more complex functions in a second NFC device, without adding additional electronic complexity to the NFC system 200 or the NFC devices, such as 270 and 275.

Another feature of one embodiment of the invention it takes advantage of sensors and other electronics that are already present in many NFC devices to enable performance of functions that are not conventionally available in NFC devices.

There have been described novel NFC methods, systems and devices. Now that embodiments of the invention have been described, those skilled in the art will be able to adapt them to other NFC methods, systems and devices. It will also be evident to those skilled in the art that the various parts of the embodiments of the invention may be combined in many different ways. It should be understood that each of the processes and apparati described can be combined with any of the other processes and apparati. After review of this disclosure, additional advantages and modifications will readily appear to those skilled in the art. The invention therefore is not limited to the illustrative examples shown and described, but is defined by the following claims.

What is claimed is:

1. A method for operating a near field communications (NFC) device, said method comprising:
associating a first sensor input into a first NFC device with a function of a second NFC device, said first sensor input being different than an input that launches an NFC operation;
bringing said first NFC device into proximity to said second NFC device, detecting said proximity, and, at an NFC launch time, launching an NFC operation between said first NFC device and said second NFC device;
sensing said first sensor input into said first NFC device during a time window including said NFC launch time;
communicating instructions from said first NFC device to said second NFC device to execute said function; and
executing said function in said second NFC device.

2. A method as in claim 1 wherein said sensing during a time window comprises sensing between a first time before said launching and a second time after said launching.

3. A method as in claim 1 wherein said sensing said first sensor input comprises sensing an input from a device selected from one or more of the following devices: a proximity sensor; an accelerometer; a gyroscope; a magnetometer; a light sensor; a GPS sensor; a clock; a finger print sensor; a microphone; and a direction finder.

4. A method as in claim 1 wherein said sensing a first sensor input comprises sensing a parameter selected from the group consisting of: the direction or speed of movement of said first NFC device with respect to said second NFC device; the orientation of said first NFC device with respect to said second NFC device; the position of said first NFC device with respect to said second NFC device; the position of said first NFC device or said second NFC device with respect to an object that is not said first NFC device nor said second NFC device; the ambient light at the location of said first NFC device or said second NFC device; the strength or direction of the earth's magnetic field at the location of said first NFC device or said second NFC device; the distance between said first NFC device and said second NFC device; a fingerprint; and a sound.

5. A method as in claim 1 wherein said function comprises a function selected from the group consisting of: zooming; scrolling; changing sound volume; displaying a selected display; transferring a file; and activating a control function.

6. A method as in claim 1 wherein said time window is five minutes or less.

7. A method as in claim 6 wherein said time window is one minute or less.

8. A method as in claim 7 wherein said time window is thirty seconds or less.

9. A method as in claim 1 wherein:
said associating comprises associating the combination of said first sensor input into said NFC device and a second input into said NFC device with said function of said second NFC device; and
said sensing comprises said sensing said first sensor input into said first NFC and said second input into said first NFC device during said time window including said NFC launch time.

10. A method as in claim 5 wherein said first NFC device comprises a display and said second input into said first NFC device is selected from the group comprising: a GPS location; and a content of said display.

11. A method as in claim 10 wherein said content comprises a picture on said display.

12. A near field communication device comprising:
a near field communication (NFC) transceiver for receiving and sending NFC signals, said NFC signals including an NFC launch signal; a memory; and a microprocessor;
a sensor for sensing a first physical parameter and for generating a first sensor signal characteristic of said first physical parameter;
a clock for generating a time signal; and
an algorithm stored in said memory, said algorithm: configured to correlate a first function to be performed by a separate NFC device with said first sensor signal; configured to launch an NFC operation upon said NFC receiver detecting an NFC launch signal; configured to, responsive to said time signal, determine a time window including the time of said launch of said NFC operation; and, configured to communicate instructions to execute said first function upon receiving said first sensor signal within said time window.

13. An NFC device as in claim 12 wherein said sensor is selected from the group consisting of: a proximity sensor; an accelerometer; a gyroscope; a magnetometer; a light sensor; a GPS sensor; a clock; a finger print sensor; a microphone; and a direction finder.

14. An NFC device as in claim 12 wherein said first sensor signal is selected from a group of signals consisting of signals characteristic of: the direction or speed of movement of said NFC device with respect to said separate NFC device; the orientation of said NFC device with respect to said separate NFC device; the position of said NFC device with respect to said separate NFC device; the position of said NFC device or said separate NFC device with respect to an object that is not said NFC device nor said separate NFC device; the ambient light at the location of said NFC device or said separate NFC device; the strength or direction of the earth's magnetic field at the location of said NFC device or said separate NFC device; the distance between said NFC device and said separate NFC device; a fingerprint; and a sound.

15. A near field communication (NFC) system, comprising:
a wireless management system communicating with a wireless network, said wireless network including: a microprocessor, a clock for producing a time signal; a first NFC device having a first sensor for sensing a physical parameter and providing a first sense signal characteristic of said physical parameter; and
said wireless management system further comprising a computer readable medium embodying instructions for directing said processing unit to:
associate said first sense signal with a first function of a second NFC device;
store instructions for an NFC operation;
detect the proximity of said first NFC device to said second NFC device and launch said NFC operation in said second NFC device in response to said proximity detection;
responsive to said time signal, generate a time window including the time of said launching of said NFC operation;
receive said first sense signal; and
in response to receiving said first sense signal within said time window, communicate instructions from said first NFC device to said second NFC device to execute said first function.

16. An NFC communication system as in claim 15 wherein said sensor is selected from the group consisting of: a proximity sensor; an accelerometer; a gyroscope; a magnetometer a light sensor; a GPS sensor; a clock; a finger print sensor; a microphone; and a direction finder.

17. An NFC system as in claim 15 wherein said first sensor signal is selected from a group of signals consisting of signals characteristic of: the direction or speed of movement of said NFC device with respect to said separate NFC device; the orientation of said NFC device with respect to said separate NFC device; the position of said NFC device with respect to said separate NFC device; the position of said NFC device or said separate NFC device with respect to an object that is not said NFC device nor said separate NFC device; the ambient light at the location of said NFC device or said separate NFC device; the strength or direction of the earth's magnetic field at the location of said NFC device or said separate NFC device; the distance between said NFC device and said separate NFC device; a fingerprint; and a sound.

18. A NFC system as in claim 15 wherein:
said instructions to associate comprise instructions to associate the combination of said first sense signal and a second input into said NFC device with a second function of said second NFC device; and
said instructions to communicate instructions for said first NFC device to said second NFC device comprise instructions to, in response to receiving said first sense signal and said second input during said time window including said NFC launch time, communicate instructions from said first NFC device to said second NFC device to execute said second function.

19. An NFC system as in claim 15 wherein;
said first sensor signal is selected from a group of signals consisting of signals characteristic of: the direction or speed of movement of said NFC device with respect to said separate NFC device; the orientation of said NFC device with respect to said separate NFC device; the position of said NFC device with respect to said separate NFC device; the position of said NFC device or said separate NFC device with respect to an object that is not said NFC device nor said separate NFC device; the ambient light at the location of said NFC device or said separate NFC device; the strength or direction of the earth's magnetic field at the location of said NFC device or said separate NFC device; the distance between said NFC device and said separate NFC device; a fingerprint; and a sound; and
said second input is selected from: a location determined from a global positioning system (GPS); and the content of a display.
